(19) United States
(12) Patent Application Publication
(10) Pub. No.: US 2004/0254724 A1
(43) Pub. Date: Dec. 16, 2004

(54) Methods, devices and system for handling position-related information of cellular equipment

(75) Inventor: Arto Mattila, Lempaala (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/799,572

(22) Filed: Mar. 11, 2004

(30) Foreign Application Priority Data
Mar. 11, 2003 (WO) PCT/IB03/00869

(51) Int. Cl. G01C 21/30

(52) U.S. Cl. 701/209

(57) ABSTRACT

The present invention provides methods for handling of location information, networked and serving entities for operating the methods and a system comprising one or more entities. The method includes requesting location information from a networked entity that generates an invocation response that contains a location invocation document including at least an instruction to the networked entity to transmit location information for being provided for performing location-based services being operated on a serving entity. The invocation response is bound to a communication protocol being composed of a header section and a body section. The location invocation document is comprised in said body section and the invocation response is transmitted to the networked entity. The invention is also directed to such a networked entity, as well as a method for transmitting an application response in consequence to a delivery request.

### CROSS-REFERENCE TO RELATED APPLICATIONS

This application claims priority under 35 USC §119 to International Patent Application No. PCT/IB03/00869 filed on Mar. 11, 2003.

### TECHNICAL FIELD

The present invention is directed to methods and systems to determine information about positions and/or locations of mobile communication equipment, especially mobile communication terminals.

### BACKGROUND OF THE INVENTION

A position/location information may relate to a set of data defining the position/location of mobile communication equipment in relationship to a reference coordinate system, having an application-specific data format and/or being based on or derived from position information such as geographically coded information e.g. street names, altitudes, velocities etc. The determination of such position/location information allows for providing a broad number of applications and services being based thereon, employing it, assisted thereby and depending thereon, respectively. In general, location featured applications and services will become one of the coming key features and solutions therefor are just under development. From the execution point of view, the application scheme for location services includes many variants of functionality. Location services may be utilized by a stand-alone terminal application and/or an application may be based on a client-server model where either client or server may execute that particular part of operation which initiates the positioning/locating functionality. Positioning/locating functionality may be implemented by a location service (LCS) concept, such as defined in the ₃^{rd} Generation Partnership Project (3GPP) with respect to GSM (global system for mobile communications) and UMTS (universal mobile telecommunication services), or by a piece of autonomous equipment.

The function of most location applications require one or more network-based application servers to have the location/position in suitable coding (in any form) to be available as such or for re-processing. There are standards available as to how the position/location can be invoked from one or more position/location sources, which might be either resident in the mobile terminal(s) or network-based entity (entities).

The current standards apply different non inter-operable communication protocols and frameworks depending of the location source from which location/position information is to be conveyed. Two main concepts shall be discussed: location service (LCS) functionality based on cellular standards, such as 3^{rd} Generation Partnership Project (3GPP) standard, and WAP (wireless application protocol) location framework standardized by the WAP Forum. The 3GPP based location service (LCS) functionality provision is based on a gateway mobile location center (GMLC) supporting different kinds of location services (LCS) offered in a standardized Le interface, which may support a mobile location protocol (MLP) specified by the Location Inter-operability Forum (LIF). The MLP, employed in Le interface, allows external service provider to access the location services (LCS). The corresponding entity to the GMLC in 3GPP2 based LCS architecture is called mobile positioning center (MPC), and the interface it provides to the application service providers (ASP) is called L1. 3GPP2 has not standardized a protocol for L1 yet, however any product implementation may support MLP or a corresponding protocol in that reference point. The WAP location framework also specifies procedures allowing application service providers (ASP) for accessing location services, or corresponding concept capable of providing similar services and information, provided by a mobile terminal. It must be noted that WAP Location Framework does not restrict or imply the usage to browsing, or any other certain service access methodology whatsoever.

### SUMMARY OF THE INVENTION

An object of the invention is to provide an improved interoperable method for handling location information in conjunction with network-based application server supporting location-based services. Further objects of the invention are to provide corresponding network-enabled devices, particularly mobile terminals and application servers, and a system thereof performing the aforementioned inventive method.

The advantages of the present invention is provide a consistent terminal location protocol (TLP) framework, especially in conjunction with a mobile terminal accessing location-based services of one or more application servers, providing required location information for operating the location-based services with its own location information. The inventive concept, the mobile location services framework, includes the positioning/locating functionality and the location-based service functionality altogether, as any form of a configuration between mobile terminals and network equipment employed. The present invention provides an enabling protocol, called as terminal location protocol (TLP), to be employed between mobile terminals and application servers. Each one may represent location application and location server in the mobile location services framework.

The inventive terminal location protocol (TLP) overcomes the problem of different protocol design and protocol frameworks at least originating from the two main concepts being based on a 3GPP standard and a WAP Forum standard without considering further proprietary concepts. Moreover, even protocol frameworks of the 3GPP standard as well as the WAP Forum standard themselves differ in their design depending on the kind of location service to be employed.

The objects of the present invention are solved by the accompanying independent claims. The accompanying dependent claims represent further embodiments of the presented solutions.

According to an embodiment of the invention, a method for requesting location information from a networked entity is provided. The networked entity is able to provide location information. The method comprises generating an invocation response, binding the invocation response to a communication protocol and transmitting the invocation response to the networked entity.

The generated invocation response contains a location invocation document. The location invocation document includes at least an instruction for transmitting location information to a serving entity. The serving entity is able to operate location-based services of the requested location information. The location information may be location information about the networked entity or may be location information about another network entity not being identical with the networked entity receiving the invocation response.

The invocation response is bound to a communication protocol. The communication protocol consists structurally of a header section and a body section. The invocation response is bound in such a way to the communication protocol that the location invocation document is comprised in the body section.

According to an embodiment of the invention, the method further comprises receiving an application request, parsing the application request and identifying location information to be contained in the application request. The application request contains one or more instructions for invoking location source operated on the serving entity. The parsing operation extracts the information comprised in the application request and the identifying operation tries to identify location information required for performing the location-based services. In case that the identifying operation fails, i.e. there is no location information included in the application request, the generating of the invocation response is initiated.

According to an embodiment of the invention, the method comprises an encoding of the location invocation document contained in the invocation response. The location invocation document is either encoded as an XML-based (extended markup language) location invocation document or a WBXML-based (wireless binary extended markup language) location invocation document. A corresponding document type description (DTD), schema or any description mechanism for syntax and semantics associated to the XML-based location invocation document or the WBXML-based location invocation document defines the structure thereof and allows for a parsing thereof in a unambiguous manner when required.

According to an embodiment of the invention, the communication protocol is a hypertext transmission protocol (HTTP), a wireless application protocol (WAP) or a wireless session protocol (WSP). Further, the communication protocol is based on one of a GET procedure or a POST procedure corresponding to the hypertext transmission protocol (HTTP) standard, the wireless application protocol (WAP) standard or the wireless session protocol (WSP) standard.

According to an embodiment of the invention, a method for transmitting location information to a serving entity operating location-based services is provided. The method comprises a generating of a delivery request, a binding of the delivery request to a communication protocol and the transmitting of the delivery request to the serving entity.

The generated delivery request contains a location delivery document. The location delivery document includes location information about a networked entity and the location information is provided for performing location-based services being operated on the serving entity. The delivery request requests the results of the accordingly operated location-based services. The communication protocol is structured into a header section and a body section and the binding operation is performed such that the location delivery document is comprised in the body section.

The networked entity about which location information is included in the location delivery document may be equal to that networked entity operation the method for transmitting location information or may be another networked entity.

According to an embodiment of the invention, the method comprise an encoding of the location delivery document. The location delivery document is either encoded as an XML-based (extended markup language) location delivery document or a WBXML-based (wireless binary extended markup language) location delivery document. A corresponding document type description (DTD), schema or any description mechanism for syntax and semantics associated to the XML-based location delivery document or the WBXML-based location delivery document defines the structure thereof and allows for a parsing thereof in a unambiguous manner when required.

According to an embodiment of the invention, the communication protocol is a hypertext transmission protocol (HTTP), a wireless application protocol (WAP) or a wireless session protocol (WSP). Further the communication protocol is based on one of a GET procedure or a POST procedure corresponding to the hypertext transmission protocol (HTTP) standard, the wireless application protocol (WAP) standard or the wireless session protocol (WSP) standard.

According to an embodiment of the invention, the method comprises a receiving of an application request. The application request contains information in accordance with the performing of location-based services being operated on the serving entity as aforementioned.

According to an embodiment of the invention, a method for transmitting an application response in consequence of a delivery request is provided. The method comprises a receiving of the delivery request, an extracting of a location delivery document form the delivery request, a parsing of the location delivery document to extract location information, a performing of location-based services (LBS), a generating of an application response and a transmitting of the application response to a networked entity.

The delivery request is received from the networked entity and contains a location delivery document including location information. The location information is provided for performing location-based services being operated on the serving entity. The delivery request instructs the results of the location-based services. The location-based services are performed in accordance with the delivery request and on the basis of the extracted location information resulting in location-based service information. The generated application response is based on the location-based service information, i.e., it contains the location-based service information.

According to an embodiment of the invention, the invocation response is bound to a communication protocol being structurally composed of a header section and a body section. The invocation response is bound in such a way to the communication protocol that the location invocation document is comprised in the body section. Further, the communication protocol is a hypertext transmission protocol (HTTP), a wireless application protocol (WAP) or a wireless session protocol (WSP). Moreover, the communication protocol is based on one of a GET procedure or a POST procedure corresponding to the hypertext transmission protocol (HTTP) standard, the wireless application protocol (WAP) standard or the wireless session protocol (WSP) standard

According to an embodiment of the invention, the location delivery document is either encoded as an XML-based (extended markup language) location delivery document or a WBXML-based (wireless binary extended markup language) location delivery document. A corresponding document type description (DTD), schema or any description mechanism for syntax and semantics associated to the XML-based location delivery document or the WBXML-based location delivery document defines the structure thereof and allows for a parsing thereof in a unambiguous manner when required.

According to an embodiment of the invention, a software tool for handling of location information is provided. The software tool comprises program portions for carrying out the operations of the aforementioned methods when the software tool is implemented in a computer program and/or executed.

According to an embodiment of the invention, there is provided a computer program product for handling of location information. The computer program comprises program code portions directly loadable into a local memory of a processing device, a terminal device, a mobile communication terminal device or a networked device for carrying out the operations of the aforementioned methods when the program is executed on thereon.

According to an embodiment of the invention, a computer program product for handling of location information is provided which comprises program code portions stored on a computer readable medium for carrying out the aforementioned methods when the program product is executed on a processing device, a terminal device, a mobile communication terminal device or a networked device.

According to an embodiment of the invention a computer data signal is provided which is embodied in a carrier wave and represents instructions which when executed by a processor cause the execution of a method for requesting location information from a networked entity able to provide location information, characterized by: generating an invocation response, said invocation response containing a location invocation document including at least an instruction directed to said networked entity to transmit location information being provided for performing location-based services being operated on a serving entity; binding said invocation response to a communication protocol defining a header section and a body section; said location invocation document being comprised in said body section; and transmitting said invocation response to said networked entity. Thereby Internet applications of the invention are covered.

According to an embodiment of the invention, a networked entity for transmitting location information to a serving entity operating location-based services is provided. The networked entity comprises an encoder, a communication agent and a communication interface.

The encoder is able to generate a delivery request. The generated invocation response contains a location invocation document. The location invocation document or the message header section includes at least one instruction for transmitting location information to a serving entity. The serving entity is able to operate location-based services of the requested location information. The location information may be location information about the networked entity or may be location information about another network entity not being identical with the networked entity receiving the invocation response.

The communication agent allows for binding the delivery request to a communication protocol. The communication protocol consists structurally of a header section and a body section. The invocation response is bound in such a way to the communication protocol that the location invocation document is comprised in the body section. The communication interface can transmit the delivery request to the serving entity

According to an embodiment of the invention, the networked entity for transmitting location information to a serving entity operating location-based services is further able to operate embodiments of the aforementioned inventive method networked entity for transmitting location information to a serving entity operating location-based services.

According to an embodiment of the invention, a serving entity is provided with a means to retrieve location information from a networked entity able to provide location information. The serving entity comprises an encoder, a communication agent and a communication interface.

The encoder is able to generating an invocation response. The generated delivery request contains a location delivery document. The location delivery document includes location information about a networked entity and the location information is provided for performing location-based services being operated on the serving entity. The delivery request requests the results of the accordingly operated location-based application services.

The communication agent allows for binding the invocation response to a communication protocol. The communication protocol consists structurally of a header section and a body section. The invocation response is bound in such a way to the communication protocol that the location invocation document is comprised in the body section.

The communication interface is able to transmit the invocation response to the networked entity.

According to an embodiment of the invention, the serving entity for requesting location information from a networked entity able to provide location information is further able to operate embodiments of the aforementioned inventive method for requesting location information from a networked entity able to provide location information.

According to an embodiment of the invention, a serving entity for transmitting an application response in consequence to a delivery request is provided. The serving entity comprises a communication interface, a parser and an encoder.

The communication interface is able to receive the delivery request from a networked entity. The delivery request contains a location delivery document including location information the location information is provided for performing location-based services being operated on the serving entity. The delivery request instructs for results of the location-based services.

The parser allows for extracting the location delivery document from the delivery request and of parsing the location delivery document to extract the location information. The location-based services are operated in conjunction with the location information and in accordance with the delivery request. The encoder is able to generate an application response. The generated application response is based on the location-based service information, i.e. contains the location-based service information resulting from their operation. The communication interface is further able to transmit the application response to the networked entity.

According to an embodiment of the invention, the serving entity for transmitting an application response in consequence to a delivery request is further able to operate embodiments of the aforementioned inventive method for transmitting an application response in consequence to a delivery request.

According to an embodiment of the invention, a system for handling of location information is provided. The system comprises at least one serving entity and at least one networked entity, wherein the service entity corresponds to embodiments of the aforementioned serving entity for requesting location information from a networked entity able to provide location information and the networked entity corresponds to an embodiment of the aforementioned networked entity for transmitting location information to a serving entity operating location-based services.

According to an embodiment of the invention, the serving entity comprised in the system further corresponds to an embodiment of the aforementioned serving entity for transmitting an application response in consequence to a delivery request.

According to an embodiment of the invention, the networked entity is a mobile terminal able to provide location information. Particularly, the networked entity is a mobile terminal able to communicate via a cellular communication system such as the global system for mobile communications (GSM), the universal mobile telecommunication services (UMTS) and further cellular public land mobile networks (PLNM). Alternatively, the networked entity is a networked serving device able to provide location information about one or more mobile terminals and particularly, one or more mobile terminals able to communicate via a cellular communication system.

According to an embodiment of the invention, the serving entity is an entity provided by an application service provider, for example one or more application serving networked devices, providing location-based services or location dependent services for accessing via a networked communication (wireless or wired networked communication). The location-based services or location dependent services may be implemented as software applications on one or more application serving networked devices.

### BRIEF DESCRIPTION OF THE DRAWINGS

The invention will be described in greater detail by means of embodiments with reference to the accompanying drawings, in which

FIG. 1a shows a schematic block diagram illustrating entities involved in a conceptional framework in accordance with state of the art WAP location architecture with respect to a WAP location protocol standard proposed by the WAP Forum;

FIG. 1b shows a state of the art schematic block diagram illustrating a first operational sequence in accordance with the WAP location framework depicted in FIG. 1a;

FIG. 1c shows a state of the art schematic flow diagram illustrating a second operational sequence in accordance with the WAP location framework depicted in FIG. 1a;

FIG. 1d shows a state of the art schematic flow diagram illustrating a third operational sequence in accordance with the WAP location framework depicted in FIG. 1a;

FIG. 2a shows a schematic flow diagram illustrating a first operational sequence in accordance with the proposed terminal location protocol (TLP) with respect to an embodiment of the invention;

FIG. 2b shows a schematic flow diagram illustrating a second operational sequence in accordance with the proposed terminal location protocol (TLP) with respect to an embodiment of the invention;

FIG. 3a shows an HTTP-based response message coding in accordance with the proposed terminal location protocol (TLP) with respect to an embodiment of the invention;

FIG. 3b shows a first HTTP-based request message coding in accordance with the proposed terminal location protocol (TLP) with respect to an embodiment of the invention;

FIG. 3c shows a second HTTP-based request message coding in accordance with the proposed terminal location protocol (TLP) with respect to an embodiment of the invention;

FIG. 4a shows schematic flow diagram illustrating an operational sequence in accordance with the operation of the mobile terminal illustrated in FIG. 2a;

FIG. 4b shows schematic flow diagram illustrating an operational sequence in accordance with the operation of the application server illustrated in FIG. 2a;

FIG. 4c shows schematic flow diagram illustrating an operational sequence in accordance with the operation of the mobile terminal illustrated in FIG. 2b;

FIG. 4d shows schematic flow diagram illustrating an operational sequence in accordance with the operation of the application server illustrated in FIG. 2b; and

FIG. 5 shows a block diagram illustrating components of both a mobile terminal and an application server allowing for carrying out the aforementioned operational sequences according to an embodiment of the invention.

### DETAILED DESCRIPTION

Same or equal parts, components and/or operations shown in the figures will be referred to using the same reference numerals.

As described with reference to the technical background of the present invention, a 3GPP reference model specifies an Le interface for accessing location services provided by a gateway mobile location center (GMLC) being embodied as one or more networked serving entities being part of the core network of a public land mobile network (PLNM). The GMLC supports different kinds of location services including “basic location query”.

In accordance with the “basic location query” a location service (LCS) client, which may be an external LCS client, i.e. for instance an external application service provider, or an internal LCS client, i.e. for instance a mobile terminal subscribed to the PLNM, issues a GET request including an XML-based (XML: extended markup language) location invocation document to the GMLC. The GMLC is responsible to retrieve position/location information from the core network (CN) part and the radio access network (RAN) part of the PLNM and to return a location delivery document to the LCS client having issued the LCS request. The detailed operation in accordance with the basic location query differs essentially depending if the LCS client is an external LCS client or an internal LCS client.

Another type of location service is a “location reporting service” for e.g. timely or geographically triggered location services. LCS client requests such a triggered location service from GMLC, and GMLC responds to the CLS client with an acknowledgment whether the triggered location service request has been accepted. Then, whenever the trigger in question (either time-based i.e. an interval or geographical i.e. an area) happens, GMLC addresses an HTTP-base (HTTP: hypertext transfer protocol) POST request to the LCS client as a location report document, delivering the location information in an XML document in the body of an HTTP-based communication message. In this case, the LCS client must support HTTP-based server functionality. The LCS client retransmits an empty response to the GMLC (in this case operating as an HTTP-based client) for notification purposes.

In usage scenarios described above, 3GPP standard does not cover any definition as to how an end-user shall access an application service provider (ASP). A type of location service, the “transfer to third party” is addressed by a mobile originating location request (MO-LR). The MO-LR specifies a way for a mobile terminal to initiate a message sequence which allows for delivering location information to a third party application service provider operating location-based services. The protocol framework of the MO-LR is cellular system based, i.e. employs the mobile application part (MAP) interfaces of a PLNM. The disadvantages of a cellular system based MO-LR are obvious and concerns at least multi-modal products being able to operate in different cellular system environments. The disadvantages also concerns the addressing scheme since uniform resource locators (URL) may not be known in low layers of terminal software such that software implantation is problematic.

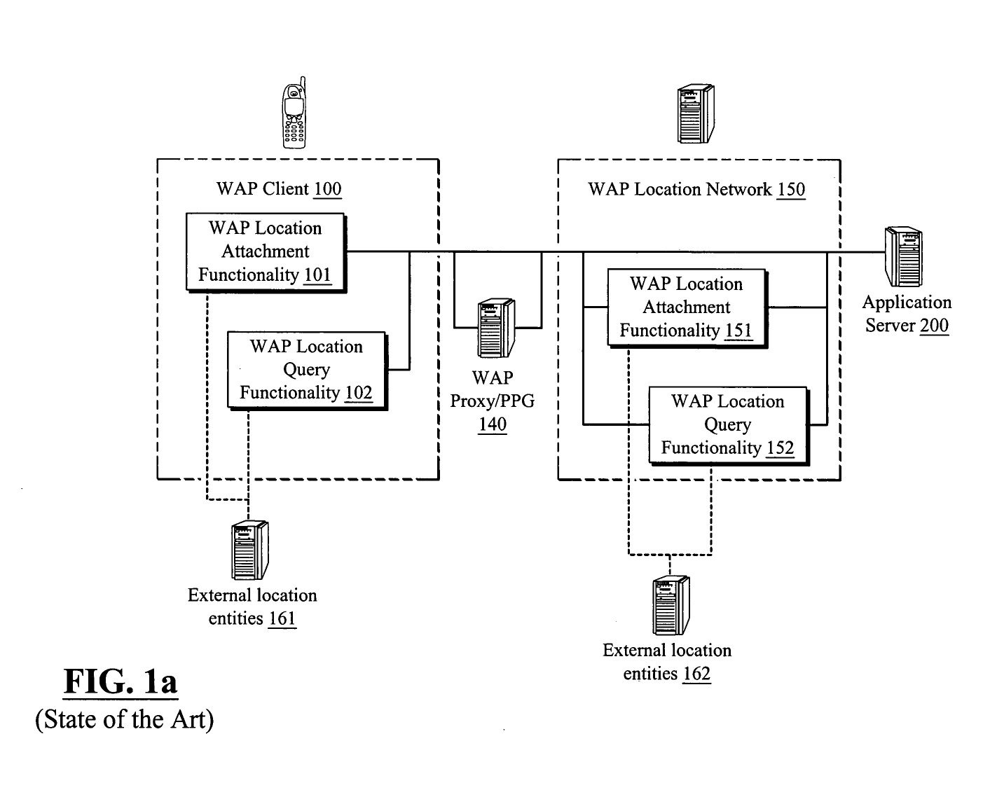

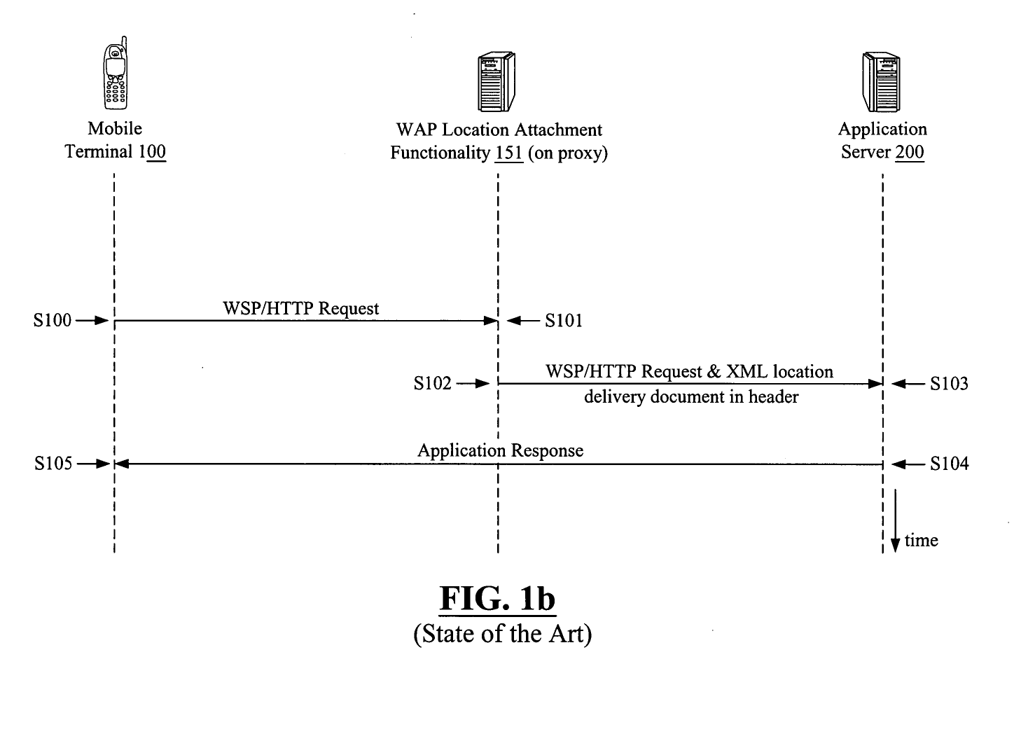

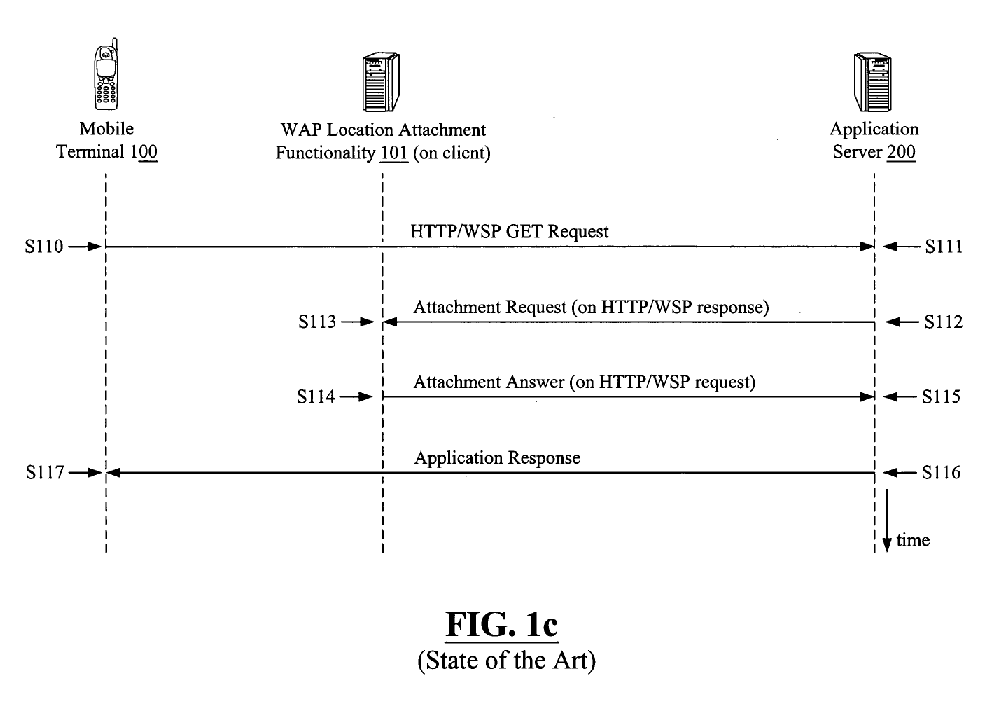

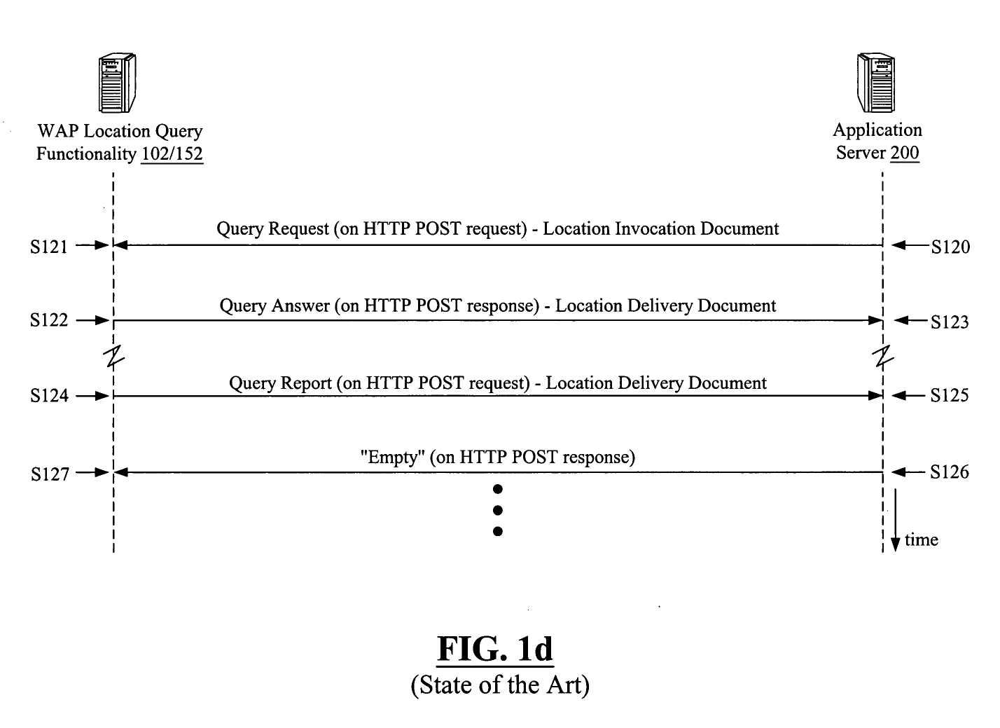

The following FIG. 1a to 1d relates to the WAP location protocol framework. FIG. 1a illustrates entities involved in a conceptional framework in accordance with WAP location architecture with respect to the WAP location protocol standard proposed by the WAP Forum. Location-based WAP services, i.e., services dependent on a location information, represent a class of applications with specific requirements.

The depiction of FIG. 1a is limited to entities that are relevant to the WAP location framework in order to enlighten the state of the art. The entities illustrated as gray-scaled boxes may be involved in the operation of the WAP location architecture and its functionality, which is defined by the WAP location framework. The solid styled lines illustrate inter-connections along which messages in accordance with the WAP location framework may be transmitted or exchanged. For example, a request may be routed via the WAP location attachment functionality 151 residing in the WAP location network 150, or it may be routed directly to the application server 200. The dotted lines indicate possible supplementary relationships to other location related entities, which may be required for operation, but are beyond the scope of the WAP location framework.

The following entities can be distinguished in FIG. 1:

a WAP client 100: The WAP client 100 may include additional entities involved in the operation such a WAP location query functionality 101 and/or a WAP location attachment functionality 102;

a WAP location network 150: The WAP location network 150 may include additional entities involved in the operation such a WAP location query functionality 151 and/or a WAP location attachment functionality 152;

an application server 200: The application server application server, in the context of the WAP location specifications, is a server executing an application, preferably in consequence of a request transmitted from a client and serves results of the executed application in the form of a response to the client. Moreover in conjunction with the WAP location framework, the application executed on the server is a location related application processing information relating to location data;

a WAP proxy or a WAP gateway 140: The WAP proxy or the WAP gateway 140 is employed to convert WSP to HTTP and vice versa, in case that the WAP client operates data communication on the basis of a WSP stack and the application server operates data communication on the basis of an HTTP stack; and

external location entities 161 and 162: The external location entities 161 and 162 are able to provide information about location. For example the external location entities 161 and 162 may be realized as dedicated location servers such as one or more gateway mobile location centers (GMLC), one or more mobile position centers (MPC), and the like.

The WAP location framework is only concerned with the three services provided by the WAP location query functionality (101 and 151, respectively) and WAP location attachment functionality (102 and 103, respectively). The WAP location framework relates to a handling of information relating to location data for obtaining information derived therefrom. The methods or procedures for obtaining/determining the information relating to location data is out of the scope of the WAP location framework.

The WAP location query functionality (101 and 151, respectively) provides the immediate query service and deferred query service. This functionality can either reside within the WAP client 100 as the WAP location query functionality 101 or supplied via a supporting server in the WAP location network 150, illustrated as WAP location query functionality 151. The WAP location attachment functionality (102 and 152, respectively) provides the location attachment service. The implementation of this functionality can also either reside within the WAP client 100 as the WAP location attachment functionality 102 or supplied via a feature enhancing proxy in the WAP location network 150, illustrated as WAP location attachment functionality 152.

The WAP location attachment functionality (101 and 151, respectively) and the WAP location query functionality (102 and 152, respectively) are logical functionalities. That is, those may be implemented in different physical entities. Examples include, but are not limited to, WAP client 100, WAP proxy/gateway 140, gateway mobile location center (GMLC), mobile position center (MPC), dedicated supporting network server etc. The realization and implementation of the aforementioned functional entities depends for example on the operator of the utilized cellular communication system.

The following schematic block diagrams illustrating operational sequences in accordance with the introduced WAP location framework will enlighten the inter-operability of the functional entities.

FIG. 1b illustrates a first operational sequence in accordance with the WAP location framework with reference to FIG. 1a. This first operational sequence is based on the location attachment service supported by the WAP location framework. A mobile terminal 100, particularly a cellular communication terminal, may request a location-based application provided by a service provider and made available via an application server 200. The mobile terminal 100 and the application server 200 are capable of data communication, i.e. are able to exchange data messages. For example a user of the mobile terminal 100 or an application carried out by the mobile terminal 100 demands a location-based or location-dependent service of the application server, for example the user of the mobile terminal 100 whishes to be informed about hotels in its immediate neighborhood.

Correspondingly in an operation S100, a request message is encoded by an application executed on the mobile terminal 100, addressed to the corresponding application server able to serve the desired information and sent thereto. The request message is bound to an appropriate data communication protocol, herein WSP or HTTP. Conventionally, application servers mostly expect HTTP-based data communication. In case the mobile terminal 100 employs WSP being normally preferable on over-the-air interfaces, a WAP gateway or WAP proxy interconnected into the data communication path between mobile terminal 100 and application server 200 transforms WSP-based data communication into HTTP-based data communication and vice versa.

In an operation S101, a WAP location attachment functionality 151 realized as a proxy entity, i.e. interposed between the data communication path of the mobile terminal 100 and the application server 200 receives the request message. The header of the request message containing the address information of the application server 200 is parsed and the WAP location attachment functionality 151 recognizes in accordance with the parsing operation that location information are required and that this location information is yet not included in the request message. Due to proxy properties of the WAP location attachment functionality 151, the WAP location attachment functionality 151 retrieves the missing location information (e.g. from the external location entity 162) and includes the location information into the header of the request message. The location information to be included is encoded as a well-defined XML-based location delivery document being based on a corresponding document type description (DTD), schema or any description mechanism for syntax and semantics of the XML document.

In an operation S102, the WAP location attachment functionality 151 realized as a proxy entity transmits the processed request message being based on the original received request message having included the location delivery document to the application server 200.

In an operation S103, the application server 200 receives the processed request message containing the location delivery document in its header and containing one or more instructions in accordance to which the application server is able to serve the desired information based on the location information attached to the request message by the WAP location attachment functionality 151.

In an operation S104, the application server 200 encodes a response message in consequence to information obtained in accordance with the received request message. The response message is sent to the mobile terminal 100.

In an operation S105, the mobile terminal 100 receives the response message. In correspondence with the above described example request for a hotel in the immediate neighborhood, the response message contains information about one or more hotels including for example names, addresses, prices of the rooms, room availability information, map information, and the like. As it can be seen, the information is based on the location information included by the WAP location attachment functionality 151.

FIG. 1c illustrates a second operational sequence in accordance with the WAP location framework with reference to FIG. 1a. The illustrated operational sequence shown in FIG. 1b is based on a WAP location attachment functionality 151 realized as a proxy entity, i.e. interposed into the data communication of the mobile terminal 100 and the application server 200. The following operational sequence may be operated to provide the same information according to the aforementioned example but the WAP location attachment functionality responsible for including the required location information into the request message may be operated on the requesting client, i.e. on the mobile terminal 100. This second operational sequence relates analogously to an alternative operational procedure of the location attachment service.

In an operation S110, the mobile terminal device encodes the request in the form of a WSP-based or HTTP-based GET request message and transmits the request message to the application server 200.

In an operation S111, the application server 200 receives the request message and parses the information contained therein. The parsing results in that a location-based application operation is requested but the request messages lack of the location information required therefor.

In an operation S112, the application server 200 encodes a response in the form of a WSP-based or HTTP-based GET response message and transmits the response the WAP location query functionality 101, to the mobile terminal 100 implementing the WAP location query functionality 101.

In an operation S113, the WAP location query functionality 101 operated on the mobile terminal 100 receives the WSP-based or HTTP-based GET response message for requesting location information. The response message is parsed and the requested location information is retrieved (e.g. from the external location entity 161).

In an operation S114, the WAP location query functionality 101 encodes a request in the form of a WSP-based or HTTP-based GET request message. The retrieved location information are included into the header of the WSP-based or HTTP-based GET request message. The location information to be included is encoded as a well-defined XML-based location delivery document being based on a corresponding document type description (DTD), schema or any description mechanism for syntax and semantics of XML documents. This composed WSP-based or HTTP-based GET request message is transmitted back to the original application server 200.

In an operation S115, the application server 200 receives the request message from the WAP location query functionality 101 and parses the header of the request message to obtain the contained location information. The parsing operation is performed in accordance with the document type description (DTD), schema or any description mechanism for syntax and semantics with respect to which the XML-based location delivery document is encoded.

The application server 200 has now available the location information and the location-based application serves the requested information in conjunction therewith.

In an operation S116, the application server 200 encodes a response in from of a WSP-based or HTTP-based GET response message containing the information obtained from the location-based application.

In an operation S117, the mobile terminal 100 receives the response message. In correspondence with the above described example, the request for a hotel in the immediate neighborhood, the response message contains information about one or more hotels. As it can be seen, the information is based on the location information included by the WAP location attachment functionality 101.

FIG. 1d illustrates a third operational sequence in accordance with the WAP location framework with reference to FIG. 1a. The operational sequences presented with references to FIG. 1b and FIG. 1c both illustrate a single WAP client request (originated from the mobile terminal 100) for information resulting of a location-based application and therefore operational procedures of the location attachment service are involved. This third operational sequence relates to an application server based location query supported by the WAP location query functionality (102 and 152, respectively) provided by the WAP location framework and particularly, WAP location query functionality (102 and 152, respectively) supports immediate query services and deferred location query services. In contrast to the location attachment service, one or more location requests are originated from the application server 200.

In an operation S120, the application server 200 requires location information for operation. Therefore, the application server 200 encodes a query request containing a location invocation document for requesting location information via the WAP location query functionality (102 and 152, respectively). The query request is analogously encoded in the form of a well-defined XML-based location invocation document in correspondence with an appropriate document type description (DTD), schema or any description mechanism for syntax and semantics of XML documents. The encoded location invocation document is embedded into a body of an HTTP-based or WSP-based POST request query message. The embedding of the location invocation document into the body of the communication message in accordance with immediate and deferred query services is in contrast to the attaching of the location invocation document to the header of the communication message in accordance with location attachment services (as referred to in FIG. 1c).

The encoded query request message is transmitted to an entity providing the required WAP location query functionality (102 and 152, respectively) for processing this encoded query request message.

In an operation S121, the WAP location query functionality (102 and 152, respectively) receives the HTTP-based or WSP-based POST request query message, parses the contained XML-based location invocation document in accordance with the corresponding document type description (DTD), schema or any description mechanism for syntax and semantics of XML documents and retrieves location information corresponding to the location invocation document. The retrieving of location information involves data communication with further location serving entities such as the external location entities 161 and 162, respectively.

In an operation S122, the WAP location query functionality (102 and 152, respectively) encodes a query response containing the retrieved location information. The query response is analogously encoded in the form of a well-defined XML-based location delivery document in correspondence with an appropriate document type description (DTD), schema or any description mechanism for syntax and semantics of XML documents. The encoded location delivery document is embedded into a body of an HTTP-based or WSP-based POST response query message. The embedding of the location delivery document into the body of the communication message in accordance with immediate and deferred query services is in contrast to the attaching of the location delivery document to the header of the communication message in accordance with location attachment services (as referred to in FIG. 1b and 1c).

The HTTP-based or WSP-based POST response query message is transmitted back to the application server 200.

In an operation S123, the application server 200 receives the HTTP-based or WSP-based POST response query message and parses the contained location delivery document coding the location information in the form of a well-defined XML-based document.

In case of a query request encoded and transmitted in the operation S120 requesting immediate location query services the operational sequence is finished. Alternatively, the query request encoded and transmitted in the operation S120 may request deferred location query services resulting in a predefined number or a timed sequence of location information transmitted to the application server 200.

In an operation S124, the WAP location query functionality (102 and 152, respectively) encodes a query report containing retrieved location information. The encoding of the query report may be event driven or frequency driven, i.e. encoding may be initiated by a certain pre-defined change in the location information or by autonomously starting the encoding procedure at the end of a pre-defined period of time. The query report is analogously encoded in the form of a well-defined XML-based location delivery document. The encoded location delivery document is embedded into a body of an HTTP-based or WSP-based POST request query report message. The HTTP-based or WSP-based POST request query report message is transmitted to the application server 200.

In an operation S125, the application server 200 receives the HTTP-based or WSP-based POST query report request message and parses the contained location delivery document coding the location information in the form of a well-defined XML-based document.

In an operation S126, the application server 200 notifies the receiving of the HTTP-based or WSP-based POST query report request message by encoding an “empty” HTTP-based or WSP-based POST query report response message.

In an operation S127, the WAP location query functionality (102 and 152, respectively) receives the notifying “empty” HTTP-based or WSP-based POST query report response message indicating to the WAP location query functionality (102 and 152, respectively) that the application server 200 has received successfully the previous HTTP-based or WSP-based POST query report request message.

The operations S124 to S127 are repeated with each query report to be sent from the WAP location query functionality (102 and 152, respectively) to the application server 200. A dedicated deferred location query service stop request allows terminating the operational sequence S124 to S127.

The following description relates to the inventive terminal location protocol (TLP) which is designed to be applicable for location invocations, location deliveries and location reports independent of being originated or composed by a mobile terminal or by a dedicated network-based server in the view of reporting location information. Therefore, the terminal location protocol (TLP) provides a well-defined XML-based location delivery document bound similarly to a location message (which may be based on HTTP or WSP data communication) regardless of its origin. The following description of the terminal location protocol (TLP) is given with respect to a mobile terminal able to provide location information. It is to be understood, the terminal location protocol (TLP) is not limited thereto. A dedicated network-based proxy device may replace the mobile terminal as location information providing entity, meaning the dedicated network-based proxy device is operable with the described terminal location protocol (TLP) in an equal and analogous way, respectively.

The proposed TLP simplifies a number of certain operations previously performed by application service providers (ASP). For example, an initiation of triggered location report services such as deferred location services has not always been operated by the ASP receiving the triggered location reports. Instead such triggered location report services can be initiated by a user or the mobile terminal itself (autonomously or on an initiation signal), respectively and employed in the first service request to the ASP running a location-based application server. Moreover, in case an ASP desires and/or requires to obtain location information about a certain mobile terminal, for example the mobile terminal of a certain user, the ASP does not have to address an appropriate location request to a dedicated location information serving entity, e.g. a location server operated by an operator of a public mobile land mobile network (PLNM), instead the subscriber of the requested service, i.e. the mobile terminal or the user of the mobile terminal is responsible for initiating a certain location service for providing location information to the ASP, wherein the initiation may be an autonomous one or a may be based on a contact request, for example to the operator of the PLNM. This procedure is applicable regardless of the kind of location service, i.e. whether the location service is an one-time location (immediate), a triggered (deferred) location reporting service. Moreover, in case that a mobile terminal is operable as a location information source, it is possible for an ASP to apply the same protocol mechanism independent on the kind of location services, i.e. immediate, deferred or geographical triggered location services.

The proposed TLP is also operable with certain advanced location services, for example, in case the mobile terminal is in possession of its own location information. The location information may be obtained from a location determining hardware module such as global positioning system (GPS) module, or may be provided in any other form to the mobile terminal, e.g. conveyed by a cellular communication system to which the mobile terminal is subscribed. In this case, the mobile terminal may encode the available location information (longitude and latitude in WGS84 datum or any co-ordinate system) in a location delivery document e.g. encoded in the form of an XML-based document being bound to a WSP-based or HTTP-based GET request and transmit this request to an application service provider operating a geographical information system (GIS) to receive location-based information such as a street name or the like therefrom. The response containing the requested location-based information is analogously encoded in the form of an XML-based document being bound to a corresponding WSP-based or HTTP-based GET response.

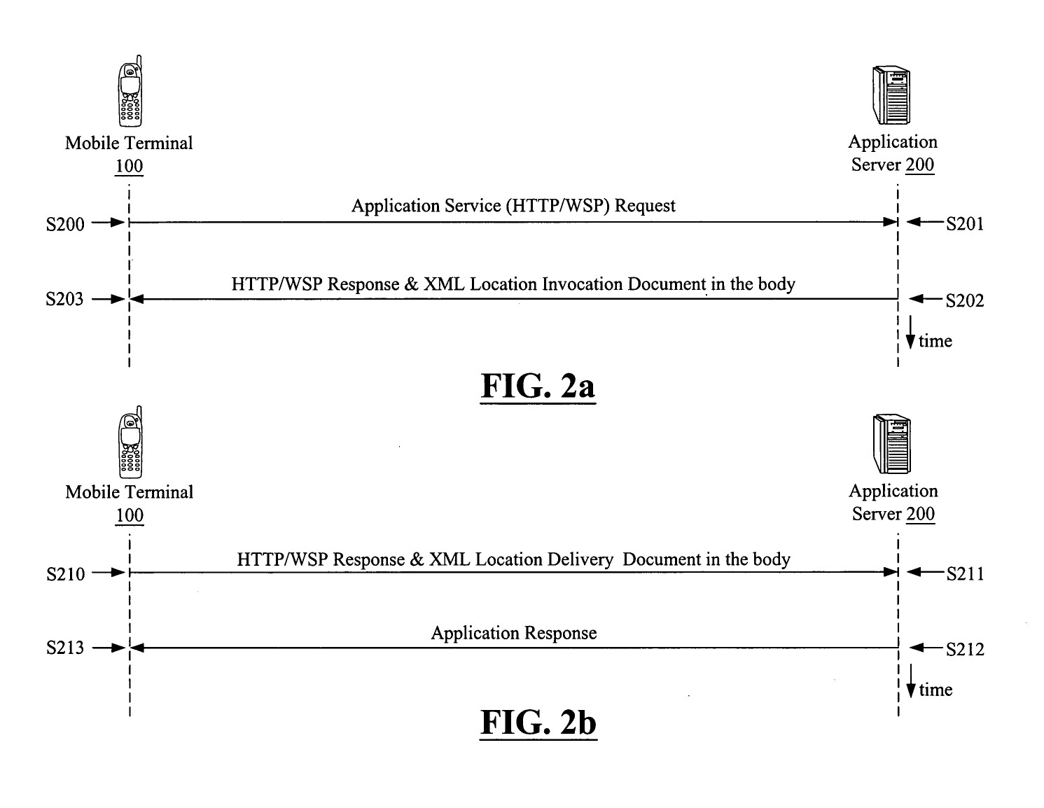

FIG. 2a illustrates a first operational sequence in accordance with the inventive terminal location protocol (TLP) with respect to an embodiment of the invention. A mobile terminal 100 may request a service of a location-based application provided by an application service provider (ASP) operated via an application server 200. The mobile terminal 100 and the application server 200 are able to communicate data to each other, for example via WSP-based data communication or vian HTTP based data communication, respectively. If necessary, an intermediate networked device interposed into the data communication path of the mobile terminal 100 and the application server 200 may transform a WSP-based data communication into an HTTP-based data communication and vice versa, respectively. In order to support the following description it may be assumed that a user of the mobile terminal 100 wishes to be informed about hotels in its immediate neighborhood. This information service is obviously based on the current location of the user and the mobile terminal 100, respectively, in order to result in meaningful and useable information.

In an operation S200, an application, for example an encoder such as a plug-in module of a browser, encodes an appropriate request for the location-based information provided by the application server 200. The used encoding mechanism or procedure depends on the capabilities and possibilities of the application server 200. The request is bound to a supported data communication protocol so that both the mobile terminal 100 and the application server 200 can form a request message, for example is bound to a WSP or HTTP, respectively. The binding of the request to either WSP or HTTP ensures that the data communication is independent from the used cellular communication network. In case of a WSP-based or HTTP-based request message being used to bound the request, a WSP-based or HTTP-based GET request message and a WSP-based or HTTP-based POST request message is applicable for transmitting the request. The usage of both the GET mechanism and the POST mechanism of the WSP and HTTP corresponds to the aforementioned recommendations for WSP and HTTP. The WSP-based or HTTP-based GET/POST request message is transmitted to the application server 200.

The information of the request may be based on an HTML-coding (hypertext markup language), an xHTML-coding (extended hypertext markup language), a WML-coding (extensible markup language) or any other suitable coding. The information of the request depends on the application executed on the mobile terminal 100 and the application executed on the application server 200 receiving the information contained in the request.

In an operation S201, the application server 200 receives the bound encoded request message. A decoder and parser executed on the application server 200 decodes and parses the received request which contains information dedicated to a certain location-based application, for example the hotel retrieval application, to be operated appropriately. With reference to the embodiment presented herein, the parsing of the request results in that the request contains information requesting location services but the request lacks location information required therefore.

In an operation S202, in consequence to the lack of required location information an encoder operable with the application server 200 encodes a response in accordance with the received request informing the mobile terminal 100 that location information is required. A location invocation document is embedded in the response. The location invocation document may be a well-defined XML-based document being defined in conjunction with a document type description (DTD) or schema, alternatively, allowing for parsing (interpreting) the XML-based document in a unique manner. The location invocation document is encoded in the body of the response and the supported data communication protocol is employed for binding the response to form a response message. Analogously, WSP or HTTP may be employed as communication protocols. In case of a WSP-based or HTTP-based response message being used to bound the response, a WSP-based or HTTP-based GET response message and a WSP-based or HTTP-based POST response message depending of the kind of WSP-based or HTTP-based request message is applicable for transmitting the response. The WSP-based or HTTP-based GET/POST response message is transmitted to the mobile terminal 100.

In an operation S203, the mobile terminal 100 receives the bound encoded response message. A decoder and parser executed on the mobile terminal 100 decodes and parses the received response containing the location invocation document indicating to the mobile terminal 100 or an application executed thereof for processing the information contained in the received response, respectively, that location information of the mobile terminal 100 is required for the requested application service, appearing as a location-based service.

FIG. 2b illustrates a second operational sequence in accordance with the inventive terminal location protocol (TLP) with respect to an embodiment of the invention. In view of the example illustrated above but without limiting thereto the operational sequence presented with reference to FIG. 2b may be seen as a consequence to the operational sequence presented with reference to FIG. 2a.

In an operation S210, an application, for example an encoder such as a plug-in module of a browser, encodes an appropriate request for the location-based information provided by the application server 200. The used encoding mechanism or procedure depends on the capabilities of the application server 200. The request contains a location delivery document for providing location information to the application server 200 or for an application of the application server 200 processing the provided location information. The location delivery document may be a well-defined XML-based document being defined in conjunction with a document type description (DTD), schema or any description mechanism for syntax and semantics of XML documents allowing for parsing (interpreting) the XML-based document in a unique manner. The location delivery document is encoded in the body of the request. A supported data communication protocol operable with both the mobile terminal 100 and the application server 200 is employed for binding the encoded request to form a request message. For example WSP or HTTP may be employed as data communication protocol. The binding of the request to either WSP or HTTP ensures that the data communication is independent from the used cellular communication network. In case of a WSP-based or HTTP-based request message being used to transmit the request, a WSP-based or HTTP-based, POST or GET request message may be employed for transmitting the request. The WSP-based or HTTP-based, POST or GET request message is transmitted to the application server 200.

In an operation S211, the application server 200 receives the bound encoded request message. A decoder and parser executed on the application server 200 decodes and parses the received request containing information and instructions for a certain location-based applications, for example the hotel retrieval application. The parsing of the request results in an extracting of the location information contained in the location delivery document. The provided information is employed to operate the requested location related services accordingly.

In an operation S212, an encoder operable with the application server 200 encodes a response in accordance with the received request informing the mobile terminal 100 and the resulting information generated by the location-based application having processed the provided location information. The response is bound to the supported data communication protocol to form a response message. Analogously, WSP or HTTP may be employed as communication protocols. In case of a WSP-based or HTTP-based response message being used to bound the response, a WSP-based or HTTP-based POST response message in accordance with the WSP-based or HTTP-based GET response message is employed for transmitting the response. The WSP-based or HTTP-based, POST or GET response message is transmitted to the mobile terminal 100.

In an operation S213, the mobile terminal 100 receives the bound encoded response message. A decoder and parser executed on the mobile terminal 100 decodes and parses the received response containing the information resulting from the location-based application having been operated on the application server 200. The information of the response encoded by the application server 200 may be based on a HTML-coding (hypertext markup language), an xHTML-coding (extended hypertext markup language), a WML-coding (extensible markup language) or any other suitable coding. The information of the response depends on the application executed on the mobile terminal 100 receiving the information contained in the response.

It should be noted that the presented operational sequences referred to in FIG. 2a and FIG. 2b represent independent operational sequences. For example, a message containing a location delivery document as described above with reference to FIG. 2b is not necessarily a consequence of a message containing a location invocation document as aforementioned referred to in FIG. 2a. Consequently, a message containing a location invocation document as described above with reference to FIG. 2a is not necessarily succeeded by a message containing a location delivery document as aforementioned referred to in FIG. 2a.

It should further be understood that the present invention is not limited to the content of the XML-based documents, neither to a certain from, encoding or encapsulating mechanism or technique. The following example documents describing relevant excerpts of the total documents are derived from a current available WAP standard (Location XML Document Formats, WAP-258-LOCFORM, provided by the WAP Forum). This WAP standard is applied for the coding format of the embodiments comprising at least one of the XML-based content format, the document type, the document name, the content type, the document type definition references and the document type names (i.e. invocation and delivery, respectively). Any other XML definition may alternatively be applied and may be applied in a similar or equal manner to the inventive TLP.

Moreover, it should be indicated, that in case of HTTP-based message communication for exchanging the location documents, the RFC 2616 document relating to a standard definition of the Hypertext Transfer Protocol—HTTP in a version 1.1—proposes GET and POST procedures for transferring data. The RFC 2616 document also specifies that GET and HEAD methods should not have the significance of taking an action other than retrieval. These guidelines recommend the employment of POST methods especially in conjunction with a location delivery document to be communicated. The same recommendation applies to WSP-based message communication since WSP-based communication procedures are based on the HTTP standard.

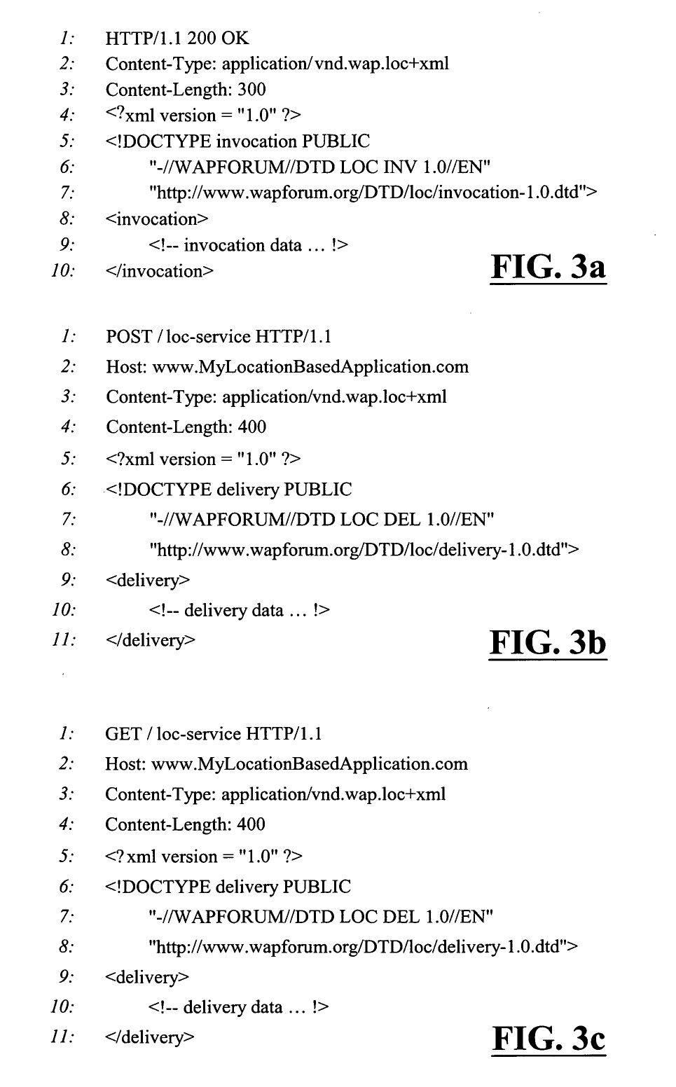

FIG. 3a shows an HTTP-based response message coding in accordance with the proposed terminal location protocol (TLP) with respect to an embodiment of the invention. Particularly, the depicted HTTP-based response message coding relates to the HTTP-based response message containing an XML-based location invocation document in the body of the HTTP-based POST/GET response message such as described in operation S202 with reference to FIG. 2a. Further, the depicted HTTP-based response message consists of two coding parts, the header and the body. The header includes the lines 1 to 3, whereas the body includes the lines 4 to 10. The depicted HTTP-based response message coding shows an excerpt of relevant parts of both the header and the body.

In the header, i.e. lines 1 to 3, the coding identifies the message as an HTTP version 1.1 response message (line 1). A MIME (multimedia internet mail extension) type is defined identifying the message as a WAP location protocol message encoded in XML (line 2) and a content length is denoted (line 3).

In the body, i.e. lines 4 to 10, the coding illustrates an excerpt of the XML-based location invocation document. The current XML version is defined in line 4 to be version 1.0. The lines 5 to 7 define the structure and the content the following XML-based coding by defining the corresponding underlying document type description (DTD), schema or any description mechanism for syntax and semantics of XML documents uniquely referred to by a URI (uniform resource identifier). Herein, the XML-based coding is based on the location XML document format (WAP-258-LOCFORM) standardized by the WAP Forum. The coding of the invocation information itself is initiated in line 8 and completed in line 10.

The location invocation document comprises the following information, but is not limited to:

requested location format;

requested quality of service;

requested criteria for response, e.g. how often and under what conditions a location information is expected; and

receiver address (if necessary).

FIG. 3b shows a first HTTP-based request message coding in accordance with the proposed terminal location protocol (TLP) with respect to an embodiment of the invention. Particularly, the depicted HTTP-based request message coding relates to the HTTP-based POST request message containing an XML-based location delivery document in the body of the HTTP-based POST request message such as described in operation S210 with reference to FIG. 2b. Further, the depicted HTTP-based POST request message consist of two coding parts, the header and the body. The header includes the lines 1 to 4, whereas the body includes the lines 5 to 11. The depicted HTTP-based POST request message coding shows an excerpt of relevant parts of both the header and the body.

In the header, i.e. lines 1 to 4, the coding identifies the message as an HTTP version 1.1 request message for employing the POST mechanism in accordance with HTTP (line 1). An address information addressing the receiving entity, i.e. for instance the application server 200, is identified (as a uniform resource location or a uniform resource identifier, line 2). A MIME (multimedia internet mail extension) type is defined identifying the message as a WAP location protocol message encoded in XML (line 3) and a content length is denoted (line 4).

In the body, i.e. lines 5 to 11, the coding illustrates an excerpt of the XML-based location delivery document. The current XML version is defined in line 4 to be version 1.0. The lines 6 to 8 define the structure and the content the following XML-based coding by defining the corresponding underlying document type description (DTD), schema or any description mechanism for syntax and semantics of XML documents uniquely referred to by a URI (uniform resource identifier). Herein, the XML-based coding is based on the location XML document format (WAP-258-LOCFORM) standardized by the WAP Forum. The coding of the delivery information itself is initiated in line 9 and completed in line 11.

The location delivery document comprises the following information, but is not limited to:

location information;

provided location information formatting;

provided quality of position (accuracy); and

status code(s), e.g. “accepted” or “service access denied”.

FIG. 3c shows a second HTTP-based request message coding in accordance with the proposed terminal location protocol (TLP) with respect to an embodiment of the invention. Particularly, the depicted HTTP-based request message coding relates to the HTTP-based GET request message containing an XML-based location delivery document in the body of the HTTP-based GET request message such as described in operation S210 with reference to FIG. 2b. Further, the depicted HTTP-based GET request message consist of two coding parts, the header and the body. The header includes the lines 1 to 4, whereas the body includes the lines 5 to 11. The depicted HTTP-based GET request message coding shows an excerpt of relevant parts of both the header and the body.

In the header, i.e. lines 1 to 4, the coding identifies the message as an HTTP version 1.1 request message for employing the GET mechanism in accordance with HTTP (line 1). An address information addressing the receiving entity, i.e. for instance the application server 200, is identified (as a uniform resource location or uniform resource identifier, line 2). A MIME (multimedia internet mail extension) type is defined identifying the message as a WAP location protocol message encoded in XML (line 3) and a content length is denoted (line 4).

In the body, i.e. lines 5 to 11, the coding illustrates an excerpt of the XML-based location delivery document. The current XML version is defined in line 4 to be version 1.0. The lines 6 to 8 define the structure and the content the following XML-based coding by defining the corresponding underlying document type description (DTD) or schema, alternatively, uniquely referred to by a URI (uniform resource identifier). Herein, the XML-based coding is based on the location XML document format (WAP-258-LOCFORM) standardized by the WAP Forum. The coding of the delivery information itself is initiated in line 9 and completed in line 11. The response/request message codings are embodied illustratively as HTTP-based response/request message codings containing an XML-based location invocation/delivery documents. The response/request message codings may be also embodied as a WSP-based response/request message codings containing WBXML-based location invocation/delivery documents. The corresponding mechanism for binding to WSP is analogous to the illustrated one. Document type descriptions (DTD) or schemas, alternatively, for the WBXML-based location invocation/delivery documents corresponding to document type descriptions (DTD) or schemas, alternatively, for the XML-based location invocation/delivery documents are available and defined.

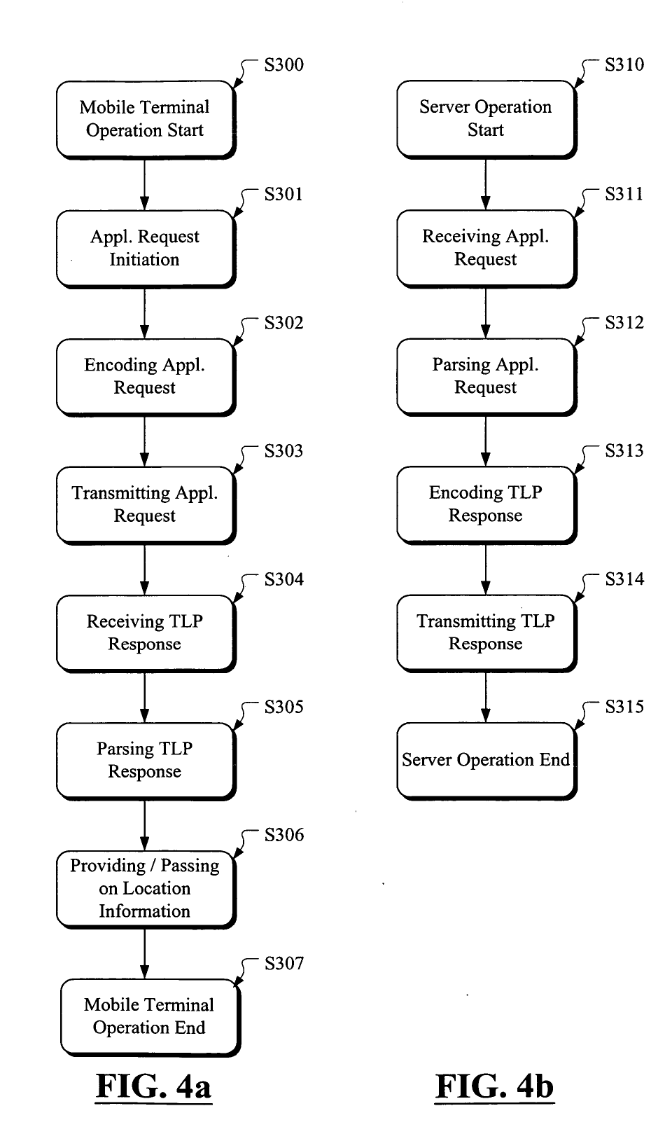

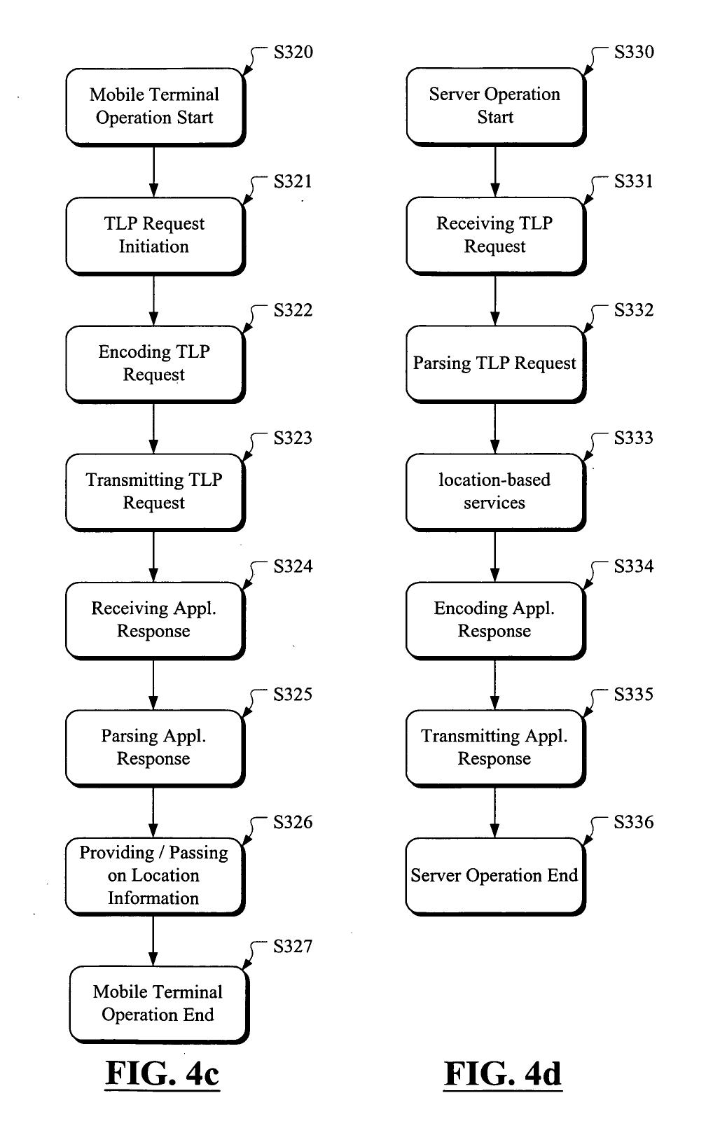

The following flow diagrams shown in FIG. 4a to FIG. 4d illustrate comprehensively the operation of the mobile terminal 100 and the application server 200 in accordance with the operational sequences referred to in FIG. 2a and FIG. 2b, respectively.

FIG. 4a illustrates an operational sequence in accordance with the operation of the mobile terminal illustrated in FIG. 2a.

In an operation S300, the operational sequence operated on the mobile terminal 100 begins.

In an operation S301, an application request is initiated by an initiator, e.g. autonomously such as timely or geographically triggered or manually by user input. In a following operation S302, an application request is encoded. The encoded application request contains instructions for a processing receiver, the application server 200, to operate accordingly. The application request may be HTML-coded, an xHTML-coded, a WML-coded or coded in any other suitable coding parsable by the receiving application executed on the application server 200. In a further operation S303, the encoded application request is bound to an appropriate communication protocol such as HTTP or WSP and subsequently transmitted to the application server. The application request may be transmitted as an HTTP-based or WSP-based GET/POST request message.

The application server 200 receives and processes the request. The operation of the application server 200 is described with respect to FIG. 4b. It may be assumed that the required location information was not included in the application request. Accordingly, the TLP response contains a location invocation document with the instructions to serve location information by a delivery in accordance with the TLP and with FIG. 2a. A response is encoded and transmitted back to the mobile terminal 100.

In an operation S304, the mobile terminal receives the TLP response. The TLP response may be received bound to an appropriate communication protocol such as HTTP or WSP and particularly, the TLP response may be received as an HTTP-based or WSP-based GET/POST TLP response message as aforementioned and in accordance with the HTTP-based or WSP-based GET/POST request message, respectively. The TLP response contains the location invocation document indicating that the requested service on the application server 200 requires location information for operation. The location invocation document may be XML-based or WBXML-based each of it being associated with a corresponding document type description (DTD), schema or any description mechanism for syntax and semantics. In a following operation S305, the information and the location invocation document are parsed, for example by a dedicated parsing application. In a further operation S306, the results of the parsing operation are provided or passed on to further applications executed on the mobile terminal 100, particularly to the initiating request application.

In an operation S306, operational sequence operated on the mobile terminal 100 is completed.

FIG. 4b illustrates an operational sequence in accordance with the operation of the application server illustrated in FIG. 2a. The operational sequence of the application server 200 is operated timely between the operation S303 and operation S304 processed on the mobile terminal 100.

In an operation S310, operational sequences operated on the application server 200 begins.

In an operation S311, the application server 200 receives the request of the mobile terminal 100. In a following operation S312, the application request is parsed for instance by a dedicated parsing application being operated on the application server 200. The parsing application or another analyzing application identifies the requested service and further recognizes that location information required for the requested service being a location-based service is missing. In a further operation S313, a TLP response is encoded by for example a dedicated encoding application being operated on the application server 200. The encoded TLP response contains a location invocation document to indicate to the mobile terminal 100 that location information is required for the requested service, and one or more instructions (e.g. including address information) for the mobile terminal 100 to deliver the location to that particular application server 200. In a subsequent operation S314, the TLP response is transmitted to the terminal device 100.

In an operation S315, operational sequence operated on the application server 200 is completed.

The encoding and binding of the application request as well as the TLP response is described in detail in above with reference to FIG. 4a.

FIG. 4c illustrates an operational sequence in accordance with the operation of the mobile terminal illustrated in FIG. 2b.

In an operation S320, operational sequence operated on the mobile terminal 100 begins.

In an operation S321, an application request is initiated by an initiator, e.g. autonomously such as timely or geographically triggered or manually by user input. The usage of TLP for request may follow a pre-configuration at the terminal software, or it may follow an earlier TLP transaction and the learned conclusion, accordingly. In a following operation S322, a TLP request is encoded. The encoded request contains a location delivery document for a processing receiver, the application server 200, to operate location-based services. The location delivery document may be XML-based or WBXML-based each of it being associated with a corresponding document type description (DTD), schema or any description mechanism for syntax and semantics. In a further operation S323, the mobile terminal 100 transmits the TLP request to the application server 200. Therefore, TLP request is bound to an appropriate communication protocol such as HTTP or WSP and particularly, the TLP request may be transmitted as an HTTP-based or WSP-based GET/POST request message.

The application server 200 receives and processes the request. The operation of the application server 200 is described with respect to FIG. 4d. It may be assumed that the request has instructed to serve information in accordance with location-based services and required location information are obtainable from the location delivery document. Accordingly, the response contains results of the location-based services processing the provided location information in accordance with FIG. 2b.

In a subsequent operation S324, an application response is received. The encoded application response contains the information resulting from the operated location-based services on the application server 200. The application response may be HTML-coded, an xHTML-coded, a WML-coded or coded in any other suitable coding parsable by the receiving application executed on the mobile terminal 100. In a following operation S325, the information contained in the application response is parsed for example by a dedicated parsing application executed on the mobile terminal 100. In a further operation S326, the results of the parsing operation are provided or passed on to further applications executed on the mobile terminal 100, particularly to the initiating request application.

In an operation S327, operational sequence operated on the mobile terminal 100 is completed.

FIG. 4d illustrates an operational sequence in accordance with the operation of the application server illustrated in FIG. 2b.

In an operation S330, operational sequences operated on the application server 200 begins.

In an operation S331, the application server 200 receives the TLP request of the mobile terminal 100. In a following operation S332, the TLP request is parsed for instance by a dedicated parsing application being operated on the application server 200. The parsing application or another analyzing application identifies the requested service and extracts the location information from the location delivery document. In a further operation S333, the requested location base services are operated in accordance with the location information. In a subsequent operation S334, an application response is encoded by for example a dedicated encoding application being operated on the application server 200. The encoded application response contains results being generated by requested location-based services. In a following operation S335, the application response is transmitted to the terminal device 100.

In an operation S336, operational sequence operated on the application server 200 is completed.

The encoding and binding of the TLP request as well as the application response is described in detail in above with reference to FIG. 4c.

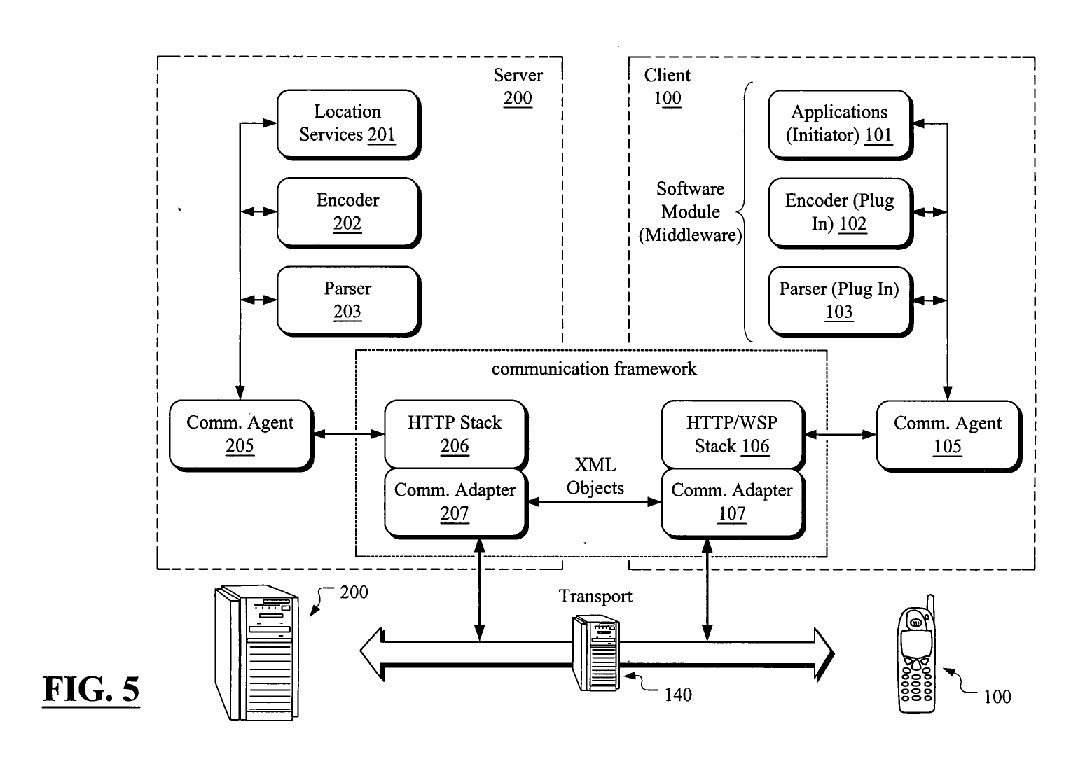

FIG. 5 illustrates components of both a mobile terminal and an application server allowing for carrying out the aforementioned operational sequences according to an embodiment of the invention. A system of a mobile terminal 100 and an application server 200 offering location-based services is provided. Both, the mobile terminal 100 and the application server 200 are able to operate the aforementioned operations sequences according to embodiments of the invention.

The mobile terminal 100 operates an HTTP stack 106 allowing for data communication with the application server 200 also operating an HTTP stack 206.

The mobile terminal 100 operates alternatively a WAP stack (WSP) allowing 106 for data communication with the application server 200 via an HTTP/WSP proxy device 140 or gateway device 140, respectively. The communication is operated on the physical layer via a communication adapter 107 of the mobile terminal 100 being an over-the-air communication interface 107 and particular co-operating with a cellular communication system such as global system for mobile communications (GSM), universal mobile telecommunication services (UMTS) and similar public land mobile networks (PLNM). The proxy device 140 or gateway device 140 is responsible for translating WSP based communication to HTTP based communication or vice versa, respectively. In general, the data communication between the mobile terminal 100 and the application server 200 is conveyed via the radio access network (RAN) to which the mobile communication terminal device 100 is associated and which offers inter-operable data communication capability to the application server 200 for example being connected an IP based network such as the internet.

Further, the mobile terminal 100 implements according to an embodiment of the invention applications 101, an encoder 102, a parser 103 and a communication agent 105.

The applications 101 comprise a number of location-based applications capable for utilizing the terminal location protocol framework for operation.

The encoder 102 may be realized as a dedicated encoding application able to encode messages in accordance with the terminal location protocol (TLP) and particular location delivery documents for example being encoded as XML/WBXML-based documents being based on document type descriptions (DTD), schemas or any description mechanisms for syntax and semantics. The encoder 102 is activated by an application initiating the encoding of a request by the encoder 102.

The parser 103 may be realized as a dedicated parsing application able to parse messages in accordance with the terminal location protocol (TLP) and particular location invocation documents for example being encoded as XML/WBXML-based documents being based on document type descriptions (DTD), schemas or any description mechanisms for syntax and semantics. The parser 103 provides parsing results to processing applications. For instance the parser 103 provides parsing results gained from an application response or a TLP request to an application having initially initiated the message sequence.

The encoder 102 and/or the parser 103 may be realized as a plug-in code section or a plug-in software module for being embedded into a complex comprising software application (such as a browser application) requiring the specific TLP related functionality of the encoder 102 and/or the parser 103 for performing data communication in accordance with the terminal location protocol framework described above. Alternatively, the encoder 102 and/or the parser 103 may be realized as a stand-alone separate software application module to be employed in conjunction with a number of location-based applications utilizing the terminal location protocol framework for operation.

The communication agent 105 is responsible for binding TLP request to the appropriate supported communication protocol such as HTTP or WSP and for extracting TLP responses from the appropriate supported communication protocol. For example, the communication agent 105 is able to embed the location delivery document into an HTTP/WSP-base, POST or GET request message to be transmitted to the application server 200.

Further, the application server 200 implements according to an embodiment of the invention location-based services 201, an encoder 202, a parser 203 and a communication agent 205.

The location-based services 201 are services being operated on the application server 200 and requiring location information for their operating. The location-based service may for example deliver the nearest hotel or the like.

The encoder 202 may be realized as a dedicated encoding application able to encode messages in accordance with the terminal location protocol (TLP) and particular location invocation documents for example being encoded as XML/WBXML-based documents being based on document type descriptions (DTD), schemas or any description mechanisms for syntax and semantics. For example, the encoder 102 is activated by an application initiating the encoding of a response by the encoder 102 in case location information is missing for performing requested location-based services. The parser 203 may be realized as a dedicated parsing application able to parse messages in accordance with the terminal location protocol (TLP) and particular delivery invocation documents for example being encoded as XML/WBXML-based documents being based on document type descriptions (DTD), schemas or any description mechanisms for syntax and semantics. The parser 203 extracts the location information from the location delivery document and supplies the extracted location information to the requested location-based services in an appropriate operable format.

The communication agent 205 is responsible for binding TLP responses to the appropriate supported communication protocol such as HTTP or WSP and for extracting TLP requests from the appropriate supported communication protocol. For example, the communication agent 105 is able to embed the location invocation document into an HTTP/WSP-base, POST or GET response message to be transmitted to the mobile terminal 100.

It shall be noted that the presented terminal location protocol (TLP) conforms to the “recommended way of use” of HTTP-base and WSP-based messages. The recommended way of use proposes that header sections of HTTP-base and WSP-based messages should contain address information, meta-data information and the like, whereas the body section of HTTP-based and WSP-based messages are supposed to contain the payload. This is, above all, of interest since the WAP location protocol framework violates this recommendation. A consistent transmitting of location invocation documents and location delivery documents contained as a payload in the body sections of HTTP-base and WSP-based messages provides an essential inter-operability issue, an application service provider can employ the same parsing functionality independent of the originating of the location related messages, i.e. of a mobile terminal or networked server. Further consistency of location invocation/delivery documents being part of the body section payload may enable the realization of an intermediate converting functionality such as location broker type of entity (device) converting for example MLP-based XML-encoded location documents to TLP-based XML-encoded location documents and vice versa, respectively.

The inventive terminal location protocol (TLP) as proposed concerns additionally privacy aspects in conjunction with location-based services. The terminal location protocol (TLP) allows a user to hold the full control and overview of the transmitted location information, whereas a proxy solution as proposed by the WAP location protocol framework allows manipulation of intermediate arranged networked devices (proxies). Especially, coding of location information in the header section of HTTP-base and WSP-based messages enables manipulations.

It will be obvious for those skilled in the art that as the technology advances, the inventive concept can be implemented in a several different number of ways. The invention and its embodiments are thus not limited to the examples described above but may vary within the scope of the claims.

What is claimed is:

1. A method for requesting location information from a networked entity able to provide location information, characterized by
generating an invocation response, said invocation response containing a location invocation document including at least an instruction directed to said networked entity to transmit location information being provided for performing location-based services being operated on a serving entity;
binding said invocation response to a communication protocol defining a header section and a body section; said location invocation document being comprised in said body section; and
transmitting said invocation response to said networked entity.

2. A method according to claim 1, characterized by
receiving an application request, said application request containing at least an instruction for requesting location service (LCS) requiring location information to be performed;
parsing said application request for extracting information comprised in said application request;
identifying location information from the extracted information; and in case said identifying of said location information fails:
initiating said generating of said invocation response.

3. A method according to claim 1, characterized by
encoding said location invocation document; said location invocation document being encoded as one of an XML-based (extended markup language) location invocation document and a WBXML-based (wireless binary extended markup language) location invocation document.

4. A method according to claim 1, characterized in that
said communication protocol is one of a hypertext transmission protocol (HTTP), a wireless application protocol (WAP) and a wireless session protocol (WSP) and
said communication protocol is based on one of a GET procedure or a POST procedure corresponding to the employed communication protocol.

5. A method for transmitting location information to a serving entity operating location-based services, characterized by
generating a delivery request, said delivery request containing a location delivery document including location information, said location information being provided for performing location-based services being operated on said serving entity; said delivery request requesting the results of said location-based services;
binding said delivery request to a communication protocol defining a header section and a body section; said location delivery document being comprised in said body section; and
transmitting said delivery request to said serving entity.

6. A method according to claim 5, characterized by
encoding said location delivery document; said location delivery document being encoded as one of an XML-based (extended markup language) location delivery document and a WBXML-based (wireless binary extended markup language) location delivery document.

7. A method according to claim 5, characterized in that
said communication protocol is one of a hypertext transmission protocol (HTTP), a wireless application protocol (WAP) and a wireless session protocol (WSP); and
said communication protocol is based on one of a GET procedure or a POST procedure corresponding to the employed communication protocol.

8. A method according to claim 5, characterized by
receiving an application request; said application request containing information in accordance with said performing of location-based services being operated on said serving entity.

9. A method for transmitting an application response in consequence to a delivery request,
characterized by
receiving said delivery request from a networked entity; said delivery request containing a location delivery document including location information, said location information being provided for performing location-based services being operated on said serving entity; said delivery request requesting the results of said location-based services;
extracting said location delivery document from said delivery request;
parsing said location delivery document to extract said location information;
performing said location-based services in accordance with said delivery request and on the basis of said location information;
generating an application response, said application response containing information resulted from said performing of said location-based services; and
transmitting said application response to said networked entity.

10. A method according to claim 9, characterized in that said delivery request is bound to communication protocol,
said communication protocol defining a header section and a body section;
said location delivery document being comprised in said body section;
said communication protocol is one of a hypertext transmission protocol (HTTP), a wireless application protocol (WAP) and a wireless session protocol (WSP); and
said communication protocol is based on one of a GET procedure or a POST procedure corresponding to the employed communication protocol.

11. A method according to claim 9, characterized in that said location delivery request is encoded as one of an XML-based (extended markup language) location delivery document and a WBXML-based (wireless binary extended markup language) location delivery document.

12. A software tool for handling of location information, comprising program portions for carrying out the operations of claim 1, when said program is implemented in a computer program for being executed on a processing device, a terminal device, a communication terminal device or a network device.

13. A computer program product for handling of location information, comprising loadable program code sections for carrying out the operations of claim 1, when said computer program is executed on a processing device, a terminal device, a communication terminal device or a network device.

14. A computer program product for handling of location information, wherein said computer program product comprises program code sections stored on a computer readable medium for carrying out the method of claim 1, when said computer program product is executed on a processing device, a terminal device, a communication terminal device or a network device.

15. A computer data signal embodied in a carrier wave and representing instructions which when executed by a processor causes the steps of claim 1 to be carried out.

16. A networked entity for transmitting location information to a serving entity operating location-based services, characterized by
an encoder (102) for generating a delivery request, said delivery request containing a location delivery document including location information, said location information being provided for performing location-based services being operated on said serving entity; said delivery request requesting the results of said location-based services;
a communication agent (105) for binding said delivery request to a communication protocol defining a header section and a body section; said location delivery document being comprised in said body section; and
a communication interface (106, 107) for transmitting said delivery request to said serving entity.

17. A serving entity for requesting location information from a networked entity able to provide location information, characterized by
an encoder (202) for generating an invocation response, said invocation response containing a location invocation document including at least an instruction to said networked entity to transmit location information for being provided for performing location-based services being operated on a serving entity;
a communication agent (205) for binding said invocation response to a communication protocol defining a header section and a body section; said location invocation document being comprised in said body section; and
a communication interface (206, 207) for transmitting said invocation response to said networked entity.

18. A serving entity for transmitting an application response in consequence to a delivery request, characterized by
a communication interface (206, 207) for receiving said delivery request from a networked entity; said delivery request containing a location delivery document including location information, said location information being provided for performing location-based services being operated on said serving entity; said delivery request requesting results of said location-based services
a parser (203) for extracting said location delivery document from said delivery request and parsing said location delivery document to extract said location information;
location-based services (201) for performing said location-based services in accordance with said delivery request and on the basis of said location information;
an encoder (202) for generating an application response; said application response containing information resulting from said performing of said location-based services; and
said communication interface (206, 207) for transmitting said application response to said networked entity.

19. A system for handling of location information, characterized by
at least one serving entity, comprising:
an encoder (202) for generating a invocation response, said invocation response containing a location invocation document including at least an instruction to said networked entity to transmit location information for being provided for performing location-based services being operated on a serving entity;
a communication agent (205) for binding said invocation response to a communication protocol defining a header section and a body section; said location invocation document being comprised in said body section; and
a communication interface (206, 207) for transmitting said invocation response to said networked entity; and
at least one networked entity, comprising:
an encoder (102) for generating a delivery request, said delivery request containing a location delivery document including location information, said location information being provided for performing location-based services being operated on said serving entity; said delivery request requesting for results of said location-based services;
a communication agent (105) for binding said delivery request to a communication protocol defining a header section and a body section; said location delivery document being comprised in said body section; and
a communication interface (106, 107) for transmitting said delivery request to said serving entity.

20. A system according to claim 19, characterized in that said at least one serving entity comprises further:
a communication interface (206, 207) for receiving said delivery request from a networked entity; said delivery request containing a location delivery document including location information, said location information being provided for performing location-based services being operated on said serving entity; said delivery request requesting for results of said location-based services
a parser (203) for extracting said location delivery document from said delivery request and parsing said location delivery document to extract said location information;
location-based services (201) for performing said location-based services in accordance with said delivery request and on the basis of said location information;
an encoder (202) for generating an application response; said application response containing information resulted from said performing of said location-based services; and
said communication interface (206, 207) for transmitting said application response to said networked entity.
